(19) United States
(12) Patent Application Publication
(10) Pub. No.: US 2002/0171579 A1
(43) Pub. Date: Nov. 21, 2002

(54) Vehicle radar concealment device bearing a pattern, and method for making such a device

(75) Inventors: Jean-Paul Artis, Plouzane (FR); Thierry Dousset, Saint-Gratien (FR); Patrick Le Sayec, Monfort L'Amaury (FR)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THALES, PARIS (FR)

(21) Appl. No.: 10/124,432

(22) Filed: Apr. 18, 2002

(30) Foreign Application Priority Data
Apr. 20, 2001 (FR) 01 05392

(51) Int. Cl. H01Q 17/00

(52) U.S. Cl. 342/1; 342/3; 342/4; 342/13

(57) ABSTRACT

Disclosed is a device to conceal a radar fitted for example into a vehicle. This device bears especially a pattern. A method to make such a device is also disclosed. The device reproduces a given pattern comprising a shiny part. It comprises at least one front part transparent to optic waves and one part having a face with a shiny appearance before the rear face of the front part. The non-shiny part of the pattern covers the rear face of the front part. The invention can be applied especially to radars positioned on the front of vehicles. The cover then reproduces the manufacturer's logo.

### BACKGROUND OF THE INVENTION

The present invention relates to a device to conceal or cover a radar fitted for example into a vehicle, this device bearing, in particular, a pattern. The invention also relates to a method for making a device of this kind. The invention can be applied for example to radars positioned in front of vehicles. In this case, the cover reproduces the manufacturer's logo.

For safety reasons in particular, it is planned to equip automobiles with radar. An exemplary known radar is the ACC (Automotive Cruise Control) radar. A radar of this kind is used especially to regulate the speed of vehicles according to traffic. In other words, the radar detects the speed and distance of vehicles that precede the radar-bearing vehicle so as to maintain an inter-vehicle safety distance. The radar can also determine obstacles in the path of the vehicle.

This radar must therefore be integrated into the front of the automobile, at a specially defined position which, for example, could be located behind the radiator grille, right on the traditional position of manufacturer's logo or emblem. In this case, the means used to conceal the radar must therefore fulfil the following functions at the same time:

letting through microwaves with the lowest possible attenuation;

and bearing a graphic representation, namely a logo which, depending on the manufacturer, may have a shiny or glossy chromium-plated or gold-plated appearance for example.

There is a known approach that makes use of an extremely fine chromium plating on a plastic or polycarbonate substrate. This technique gives good results since the logo can be seen or discerned without any problem and without confusion. However, its first drawback is that this logo causes residual losses that may easily go up to several decibels. The need to increase the range and detection quality of the new generation of radars is making this type of technique excessively penalizing and therefore inapplicable. A second drawback lies in the fact that this technique cannot be used to reproduce all the logos already known or used, especially those that have a gold-plated appearance. Since a logo, in particular, is a graphic representation of a trademark, it should be possible to reproduce it as faithfully as possible. This is an important token of recognition in automobiles.

Finally, for obvious economic reasons, a logo or any other part attached to a vehicle must cost as little as possible. In particular, it must be simple to make.

### SUMMARY OF THE INVENTION

It is an aim of the invention to overcome the above-mentioned drawbacks while at the same time enabling a cover plate to be made in a simple and economical way. To this end, an object of the invention is a device to conceal a radar, said device reproducing a given pattern comprising a shiny or glossy part and being traversed by a radar beam. The device comprises at least one front part transparent to optic waves and one part having a face with a shiny appearance before the rear face of the front part, the non-shiny portion of the pattern covering the rear face of the front part.

Advantageously, the shiny appearance of the part is obtained by at least one network of conductive wires, substantially perpendicular to the polarization of the wave emitted by the radar and placed so as to face the front part.

Advantageously, to further improve the shiny appearance of the part, it may comprise at least two networks of wires, superimposed and offset by a half-pitch.

Advantageously, the wires of a network may have the appearance of a wide variety of metals, for example chromium, silver or gold.

The wires may be crossed by electrical current, thus enabling the de-icing of the pattern.

The front part may be simply covered with a layer of paint reproducing the non-shiny portion of the pattern. This non-shiny portion may again be simply obtained by silk-screen printing.

An object of the invention is also a method for making the above-mentioned device.

### BRIEF DESCRIPTION OF THE DRAWINGS

Other features and advantages of the invention shall appear from the following description, made with reference to be appended drawings, of which:

FIG. 1 is an illustration, in a front view, of a device according to the invention bearing an exemplary pattern;

FIG. 2 is an illustration of the rear face of the front part of a device according to the invention;

FIG. 3 is an illustration by means of a view in profile of the possible constituent parts of a device according to the invention;

FIG. 4 shows a possible embodiment of a shiny part of a device according to the invention, comprising at least one network of conductive wires;

FIG. 5 is a view in profile showing another exemplary embodiment of the shiny part, comprising at least two superimposed networks of conductive wires;

FIG. 6 is a front view of a device according to the invention revealing the front portion demarcating the contours of the shiny portion of the pattern.

### MORE DETAILED DESCRIPTION

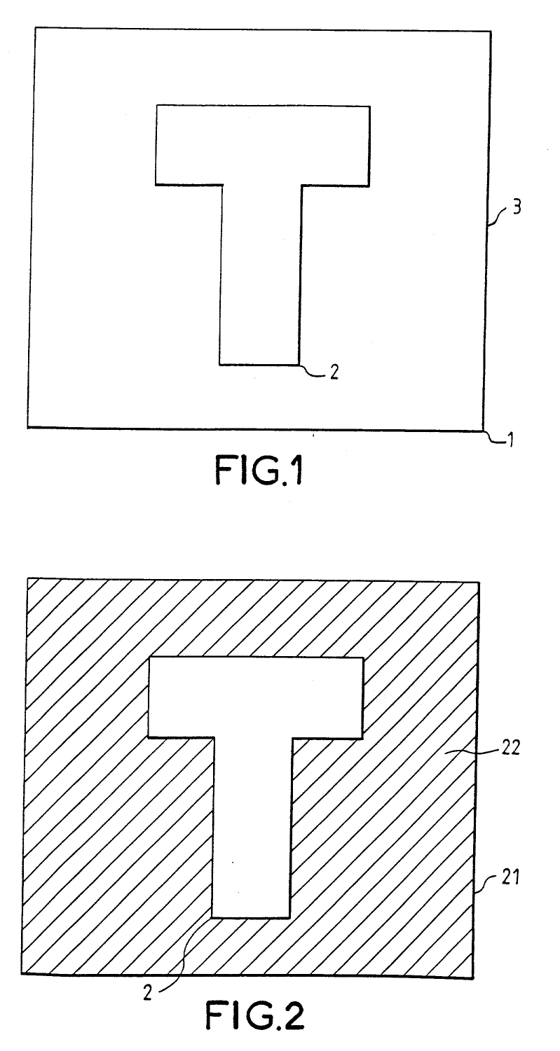

FIG. 1 illustrates a front view of a device 1 to conceal a radar fitted into a vehicle. This cover plate, located for example on the front of the vehicle, is crossed by the radar beam. This cover plate has a pattern. In the example of FIG. 1, this pattern has a T shaped portion 2 and a square 3 in which the T-shaped figure is inscribed. The following description will rely on this example. The T-shaped portion 2 may correspond, for example, to the emblem or logo of the automobile manufacturer or the like. Again in this exemplary embodiment, it is assumed hereinafter that this T-shaped portion 2 is shiny, with a chrome-plated or gold-plated appearance, or the like. More generally, the invention can be applied to any cover plate reproducing a pattern that has one or more shiny portions.

FIG. 2 illustrates a first step of the method according to the invention. More specifically, this figure illustrates the front part 21 of a cover plate according to the invention, with its front face oriented outwards and its rear face oriented towards the radar. This front part 21 is made of a material that is transparent to both microwaves and optic waves. It is made for example of transparent plastic material, such as for example polycarbonate. FIG. 2 shows the rear face. The front part bears the non-shiny portion 22 of the pattern. Advantageously, the non-shiny portion is borne by the rear face of the front part. Advantageously, the non-shiny portion is borne by the rear face of the front portion.

The method according to the invention therefore comprises a step to cover the front part within one or more contours reproducing the non-shiny portion 22 of the pattern. Preferably, the non-shiny portion 22 is reproduced on the rear face of the front portion. In this first step of the method according to the invention, the non-shiny portion 22 of the pattern is therefore for example attached to the rear face of the front part 21. Thus, this non-shiny portion 22, which is a negative shape of the shiny portion 2, covering the rear face of the front part, is for example painted or screen-printed on its rear face. A cover plate according to the invention may have a three-dimensional shape. Indeed, many emblems have a three-dimensional shape. Consequently, the front part has, for example, a three-dimensional shape obtained by a standard shaping method. In the example, the non-shiny portion 22 may be flat and the shiny portion 2 may be three-dimensional.

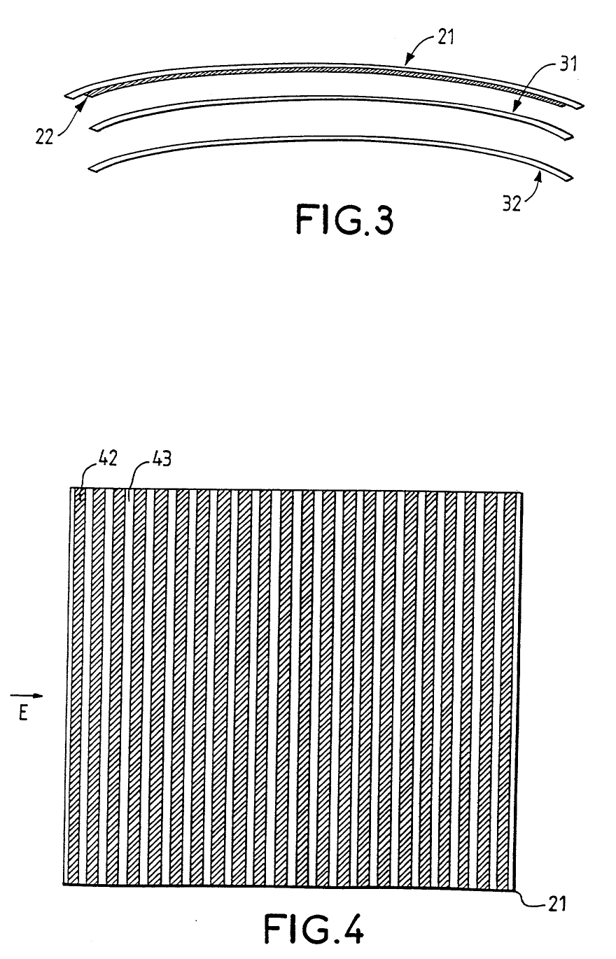

FIG. 3 shows a view in profile of other possible parts used to form a cover according to the invention. The front part 21 is shown, covered on its rear face with the non-shiny portion 22 of the pattern. The cover plate has a second part 31 that is transparent to microwaves placed so as to face the front part 21. The face of the second part 31, placed so as to face the front portion, has a shiny appearance, preferably throughout its surface. At least the portion facing the zone not covered by the rear face is shiny. Advantageously, it is simple to make the cover plate because there is no need to provide for a precise demarcation of the shiny portion, the simplest case being the one where the entire surface is shiny. The boundaries of the shiny portion are actually defined by the negative representation 22 which covers the rear face of the front portion.

If the front part is three-dimensional, the second part 31 is fitted into this part 21. The shiny part 31 is for example made of plastic. One of its faces for example is covered with a shiny film that allows microwaves to pass through adequately, with acceptable losses. This part 31 with a shiny appearance may have for example a non-metallic reflective film of the type used to make electric lamp reflectors or to provide opaqueness to windows. In a second step of the method of manufacture according to the invention, the shiny part 31 is therefore placed so as to face the front part.

The cover comprises for example a closing part 32 located in the rear, facing the radar. This part, positioned in a third possible step of the manufacturing method, then provides for the mechanical holding of the assembly. The closing part 32 of course allows microwaves to pass through. It may therefore be made of plastic. Preferably, it is optically opaque. For example it may be white. This third part 32 fits for example into the previous part 31. It is for example mechanically fixed to the front part 21. Preferably, there is no space between the parts 21,31,32. These parts are attached to one another or fitted into one another, especially to prevent excessive microwave losses. In any case, the different parts of the cover plate are preferably sized in such a way as to minimize radio electrical losses, inter alia by ensuring that the vector combination of the waves reflected on the different layers is as a weak as possible: this corresponds to minimum losses.

In certain embodiment of the cover plate according to the invention, the second part 31, comprising a shiny face, may be held by adhesion or again by mechanical means to the front part 21. In this case, the third part 32 is not necessary and may, for example, not exist.

FIG. 4 illustrates a possible embodiment of the shiny part 31. In this embodiment, the shiny part 31 comprises a network of conductive zones 42 facing the front part 21. This network of conductive zones 42 has a direction substantially perpendicular to the polarization of the wave emitted by the radar, namely the direction perpendicular to the electric field \vec{E} of the wave. This part 31 may thus comprise a network of conductive wires 42 perpendicular to the polarization of the wave emitted by the radar. Owing to the small wavelength of the band allocated to the automobile radar, the network of wires may be extremely thin and thus faithfully reproduce a shiny appearance such that it is uninterruptedly shiny. In particular, the network of wires may give a shiny appearance similar to that of solid chrome-plating of the kind that is commonly used. Preferably, especially to simplify the manufacturing, the network of wires is formed on the entire surface of the part 31.

For example, on a polycarbonate substrate, the width of the conductive zones 42, or wires may be in the range of 0.15 mm, as also the spacing 43 between two edges of zones or consecutive wires. An arrangement of this kind of the wires of the network introduces negligible microwave losses as well as a negligible phase rotation. This means that it is not necessary to make any notable modification in the radiation characteristics of the radar antenna.

This network of wires 42 may be laid on a support by any technique of metallization or etching. The etching precision required is compatible with techniques that can be used for large-scale production.

Given especially the low influence of the resistivity of a conductive wire 42 in the wave process, the network of wires may have a wide variety of metals, including especially chromium, copper, silver or gold. The conductive wires may thus consist of these metals or be lined with these metals. This makes it possible especially to obtain varied effects and reproduce especially a large number of logos.

Advantageously, the front part protects the network of wires against external corrosion, especially corrosion through climatic or mechanical factors.

FIG. 5 shows another possible embodiment of the shiny part. The network of wires as described with reference to FIG. 4 may give an appearance that could be deemed to be insufficiently shiny owing to the presence of non-metallized zones 43.

According to the invention, it is possible to make a part 31 with an uninterruptedly shiny appearance or an appearance that is close to it, by superimposing at least two networks of wires 51,52 which, for example are offset. The two networks are thus for example offset by a half pitch. Thus, if the width of a wire is, for example, 0.15 mm and the width of the spacing between wires is 0.15 mm, the pitch is equal to 0.30 mm. More generally, a pitch of the network corresponds to the width of the wire 42 plus the width of a spacing 43. The span between two planes 53,54 of the network is adapted to the wavelength in the substrate 55 between the two networks.

The first network of wires 51 is therefore separated from the second network of wires 52 by a median substrate 55 transparent to optic waves and to microwaves. A protective substrate 56 for example protects the first network of wires 51, located towards the front part 21. However, the substrate may be eliminated owing to the protection given by the front part itself. In the event of use however, this protective substrate 56 nevertheless provides protection against handling in the cover-plate manufacturing phase.

The second network of wires 52 is sandwiched, for example, between a back substrate 57, transparent to microwaves, and the median substrate 55. Preferably, the back substrate 57 is not transparent to optic waves, especially when the third part 32 is not used. In this case, the rear face of the back substrate is for example coated with paint or subjected to silk-screen printing, preferably white in color. The first network of wires 51 is fixed for example to the median substrate 55, for example by metallization. The second network of wires 52 is for example fixed to the back substrate 57, for example by metallization.

It may be necessary to meet certain sizing constraints. In particular, the thickness of the median substrate 55 must be adapted to the two networks of wires. The SWT (standing wave ratio) of the assembly formed by the two networks 51,52 and by this substrate 55 must as close as possible to 1 at the radar frequency. In particular, if the two networks are offset by a half-pitch, the complications and experiments carried out by the present Applicant have shown that this condition is suitably approached when the distance between the two networks is in the range of λ/2 where λ is the radar wavelength in the median substrate 55. This corresponds to a distance or thickness of about 2 mm in air or about 1 mm in polycarbonate. The thickness of the three substrates must furthermore be adapted so that the SWT of the assembly is as close as possible to 1 so as to minimize the radio-electrical mismatching losses. The computation of the matching thicknesses forms part of the rules of the art known in the field of microwaves.

The median substrate 55 may be replaced by air provided that the external substrates 56, 57 are adequately held by mechanical means. The stack of wire networks is not limited to two which is the number of networks shown in FIG. 5. In particular, it is possible, if necessary, to add one or more intercalary networks, provided especially that the microwave matching intervals are complied with.

Advantageously, an electric current may travel through all or a part of the wires 42 of the network. The heating of the wires thus produced may enable especially the de-icing of the logo, especially the shiny portion, and thus make this portion clearly visible, especially in wintry climates. Should several networks be superimposed, the current may cross all the networks or only the external network 51.

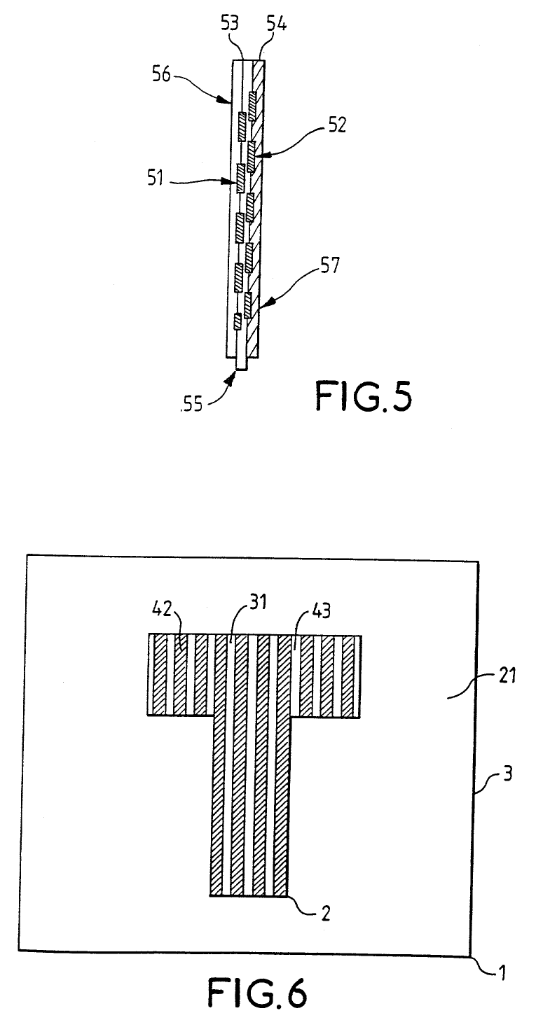

FIG. 6 illustrates a front view of a cover plate according to the invention. The shiny part 31, which comprises a network of wires 42 according to FIGS. 4 or 5, or any other shiny surface letting microwaves pass through adequately, is covered with the front part, 21, thus precisely demarcating the contours of the shiny portion 2 of the pattern 3, for example the logo. The shiny portion 2 may represent shapes other than the manufacturer's logo. In particular, it may also represent the shiny portions of the fairing, especially to camouflage the presence of a device 1 that conceals a radar. The part of the front part 21 that masks the shiny part 31 may simply have a black appearance. However, it may also advantageously represent a wide variety of colors applied to its rear face. These may for example be painted or applied by silk-screen process.

In one alternative embodiment, the non-shiny portion 22 of the pattern may be reproduced on the part 31 with a shiny appearance, comprising a shiny film or a network of wires 51, 52 according to FIGS. 4 or 5. In this case, this portion 22 may, for example, be painted or silk-screen printed directly on the part 31. Once the non-shiny portion is reproduced on this part 31, the part is placed so as to face the front part.

The second part 31 may be fitted into the front part 21. It may also be bonded to this part or fixedly joined by any other means.

The invention has been described for a cover plate reproducing a graphic pattern designed to be fitted into a vehicle, the cover plate comprising, in this case, means to be fixed to the vehicle. The invention, however, may be applied to the making of any pattern through which radar waves travel.

What is claimed is:

1. A device to conceal a radar reproducing a given pattern, comprising a shiny portion, said device being crossed by the radar beam, wherein the device comprises at least one front part transparent to optic waves and one part having a face with a shiny appearance before the rear face of the front part, the front part supporting the non-shiny portion of the pattern.

2. A device according to claim 1, wherein the non-shiny portion of the pattern is reproduced on the rear face of the front part.

3. A device to conceal a radar reproducing a given pattern, comprising a shiny portion, said device being crossed by the radar beam, wherein the device comprises at least one front part transparent to optic waves and one part having a face with a shiny appearance before the rear face of the front part, the non-shiny portion of the pattern being reproduced on the part having a shiny appearance.

4. A device according to the preceding claim, wherein the part having a face with a shiny appearance comprises, facing the front part, at least one network of conductive wires substantially perpendicular to the polarization of the wave emitted by the radar.

5. A device according to claim 4, wherein the part having a shiny appearance has at least two superimposed networks of wires.

6. A device according to claim 5, wherein the two networks are offset.

7. A device according to claim 6, wherein the two networks of wires are offset by a half-pitch

8. A device according to any of the above claims 4 to 7, wherein the first network of wires is separated from the second network of wires by a median substrate transparent to optic waves and to microwaves, the first network of wires being located toward the front part.

9. A device according to claim 8, wherein a back substrate, transparent to microwaves, holds the second wire network sandwiched with the median substrate.

10. A device according to claim 9, wherein the back substrate is not transparent to optic waves.

11. A device according to any of the above claims 8 to 10, wherein the thickness of the median substrate is in the range of λ/2 where λ is the radar wavelength in the median substrate.

12. A device according to any of the above claims 8 to 11, wherein the median substrate is air.

13. A device according to any of the above claims 4 to 12, wherein a network of wires is formed by etching on a substrate.

14. A device according to any of the above claims 4 to 12, wherein a network of wires is formed by metallization on a substrate.

15. A device according to any of the above claims 4 to 14, wherein the wires are made of chromium, copper, silver or gold.

16. A device according to any of the above claims 4 to 15, wherein all or part of the wires of the network are crossed by an electric current to deice the shiny graphic representation.

17. A device according to any of the above claims 1 to 3, wherein the shiny part is coated with a shiny film.

18. A device according to any of the above claims, wherein the non-shiny portion is painted.

19. A device according to any of the above claims 1 to 17, wherein the non-shiny portion is deposited by silk-screen printing.

20. A device according to any of the above claims, comprising a closing part located in the rear, facing the radar, to provide for the mechanical holding of the assembly.

21. A device according to claim 20, wherein the closing part is optically opaque.

22. A device according to any of the above claims, wherein the shiny part is shiny throughout its surface facing the front part.

23. A device according to any of the above claims, comprising means of attachment to a vehicle.

24. A device according to any of the above claims, wherein the pattern reproduces a manufacturer's logo.

25. A method for making a device to conceal a radar, reproducing a given pattern comprising a shiny part, said device being crossed by the radar beam, wherein the method comprises at least:
a step for covering a front part transparent to the optic waves within a contour reproducing the non-shiny portion of the pattern;
a subsequent step for positioning a second part before the front part, the second part having a face with a shiny appearance oriented toward the front part.

26. A method according to claim 25, wherein the non-shiny part of the pattern is reproduced on the rear face of the front part.

27. A method for making a device to conceal a radar, reproducing a given pattern comprising a shiny part, said device being crossed by the radar beam, wherein the device comprises at least:
a step for covering a part having a shiny aspect, within a contour reproducing the non-shiny portion of the pattern;
a step for positioning this part before a front part, the shiny face being oriented toward this front part.

28. A method according to any of the claims 25 to 27, wherein the non-shiny part of the pattern is painted.

29. A method according to any of the claims 25 to 27, wherein the non-shiny pattern is deposited by silk-screen printing.

30. A method according to any of the claims 25 to 29, comprising an additional step for positioning a closing part for the mechanical holding of the assembly.
